(19) United States
(12) Patent Application Publication
(10) Pub. No.: US 2011/0141623 A1
(43) Pub. Date: Jun. 16, 2011

(54) MAGNETIC HEAD SLIDER

(76) Inventors: Yoshinori TAKEUCHI, Ibaraki (JP); Koji TANAKA, Kanagawa (JP); Minoru KOIKE, Kanagawa (JP)

(21) Appl. No.: 12/962,419

(22) Filed: Dec. 7, 2010

(30) Foreign Application Priority Data
Dec. 10, 2009 (JP) 2009-280561

(51) Int. Cl. G11B 5/48

(52) U.S. Cl. 360/244; G9B/5.147

(57) ABSTRACT

A magnetic head slider including a first face adjacent to a recording medium, a shallow groove face formed at a first depth from the levitating face, a deep groove face formed at a second depth from said first face, where the second depth is greater than the first depth. The head slider also includes a negative pressure generating face comprising the deep groove face, first levitating faces enclosing a periphery of the negative pressure generating face on an inlet side of the head slider, and second levitating faces formed on opposite sides of the head slider, wherein the first levitating faces and the second levitating faces are separated.

### CROSS REFERENCE TO RELATED APPLICATION

This application claims priority from the Japanese Patent Application No. 2009-280561, filed Dec. 10, 2009, the disclosure of which is incorporated herein in its entirety by reference.

### BACKGROUND

In modern magnetic disk devices, when a magnetic head is in a levitated position and the magnetic head is tilted in the roll direction, the lowest point of the magnetic head is offset in the width direction. As a result, errors occur in performing contact detection. Moreover, magnetic spacing loss, adversely affecting the recording/reproduction performance occurs.

### BRIEF DESCRIPTION OF THE DRAWINGS

FIGS. 1-4 and 7-10 illustrate examples of a head slider, in accordance with embodiments of the present invention.

FIG. 5 illustrates examples of pressure distributions, in accordance with embodiments of the present invention.

FIG. 6 illustrates an example of air film rigidity, in accordance with an embodiment of the present invention.

FIG. 11 illustrates an example of a HDD, in accordance with an embodiment of the present invention.

The drawings referred to in this description should be understood as not being drawn to scale except if specifically noted.

### DESCRIPTION OF EMBODIMENTS

Reference will now be made in detail to embodiments of the present technology, examples of which are illustrated in the accompanying drawings. While the technology will be described in conjunction with various embodiment(s), it will be understood that they are not intended to limit the present technology to these embodiments. On the contrary, the present technology is intended to cover alternatives, modifications and equivalents, which may be included within the spirit and scope of the various embodiments as defined by the appended claims.

Furthermore, in the following description of embodiments, numerous specific details are set forth in order to provide a thorough understanding of the present technology. However, the present technology may be practiced without these specific details. In other instances, well known methods, procedures, components, and circuits have not been described in detail as not to unnecessarily obscure aspects of the present embodiments.

In modern magnetic disk devices, in order to improve the recording/reproduction characteristics and improve recording density, the technique has come to be adopted of calibrating the clearance of each head by using a thermal actuator (TFC) to achieve contact, then pulling up the head by the amount of the prescribed clearance, and bringing the vicinity of the element into the vicinity of the medium at about 1 to 2 nanometers (nm) during recording/reproduction. When this technique is used, the amount of levitation of the element section is minimized. However, if the levitated condition is tilted in the roll direction, the lowest point is offset from the element in the width direction, resulting in errors when performing contact detection. This therefore results in magnetic spacing loss, adversely affecting the recording/reproduction performance. Consequently, levitation tilting in the roll direction is to be reduced or suppressed.

However, in conventional technology, the pressure generated at the air bearing surface surrounding the negative pressure generating faces, provided on both sides of the slider and at the side air bearing faces linked therewith, is affected by the angle (skew angle). The skew angle is defined by the longitudinal axis of the slider with the tangential direction of the magnetic disk. As a result of a skew angle, a large positive pressure is generated at the side air bearing surface on the side where the air penetrates from outside the slider. In contrast, an air bearing surface on the side, where the air invades the side air bearing surface from the negative pressure generating face, facilitates in a paucity of flow of air from the negative pressure generating face. Accordingly, a small positive pressure is generated because of a diminished air flow. Also, the air film rigidity in the roll direction of the side air bearing face therefore becomes small.

When the air film rigidity in the roll direction is small, tilting tends to occur in the levitation condition of the roll direction at the individual heads, resulting in displacement of the lowest point: clearance loss is thereby generated and recording/reproduction characteristics are adversely affected; in addition, since the rigidity in the roll direction is low, there is a risk that contact may take place.

In various embodiments of the present invention, a large positive pressure at the side air bearing faces on both sides of the slider is generated. Accordingly, this generates a high rigidity in the roll direction.

In one embodiment, a magnetic head slider of the negative pressure type is provided with a magnetic head for reading/writing of information on a recording medium. The magnetic head slider is levitated or indirectly contacts the recording medium by the action of a bearing face using an air bearing. The bearing face includes: a levitating face that is most closely adjacent to the recording medium; a shallow groove face formed with a first depth from this levitating face; a deep groove face formed with a second depth from this levitating face, that is at least deeper than this shallow groove face; and one or more negative pressure generating faces comprising this deep groove face; and there are provided a first levitating face formed so as to enclose the periphery of this negative pressure generating face on the inlet side and a pair of second levitating faces formed on both sides of the slider, and this first levitating face and these second levitating faces are formed separated by said shallow groove faces.

In another embodiment, the width of the slider is no more than 0.7 mm.

In a further embodiment, the second levitating face presents a U shape and the open side of the U is formed on the inlet side.

In yet another embodiment, the distance from the shallow groove face to the levitating face on the inlet side of said second U-shaped levitating face is formed so as to be longer (Da) on the outside of the slider and shorter on the inside thereof (Db).

In one embodiment, the second U-shaped levitating face is formed with a width (Wa) on the outside of the slider that is wider than its width (Wb) on the inside thereof.

In another embodiment, the first levitating face that encloses the negative pressure generating face is formed so that its width spreads out to the rear, in the longitudinal direction of the second levitating face.

In another embodiment, the rearward end of the first levitating face is formed extending further rearward than the rearward end of the second U-shaped levitating face.

It should be appreciated that a magnetic disk device includes a magnetic head slider having the above characteristic features.

By separating the air bearing faces of narrow width enclosing the inlet side of the negative pressure generating face from the side air bearing faces, a large positive pressure is generated at both side air bearing faces of the slider at skew angles obtained in the range from the inner periphery to the outer periphery of the magnetic disk. Thereby making it possible to guarantee high rigidity in the roll direction. In this way, reduction in tilting of the levitation in the roll direction of the slider, reduction in magnetic spacing loss of the element, and reduction in fluctuation of levitation in the roll direction can be achieved. Consequently, disk crashes can be avoided, and the reliability of sliding of the magnetic disk device can be improved.

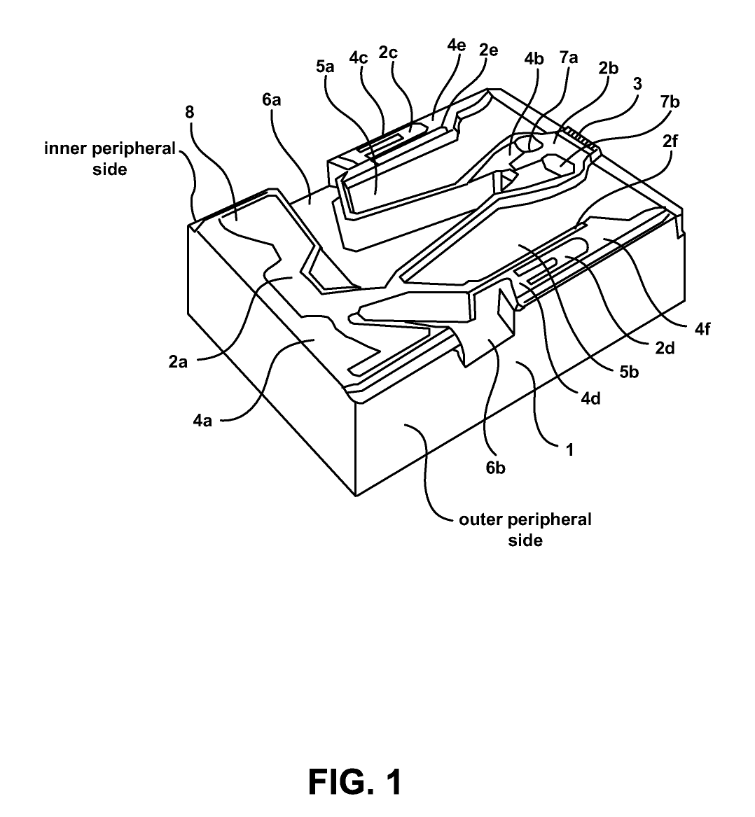

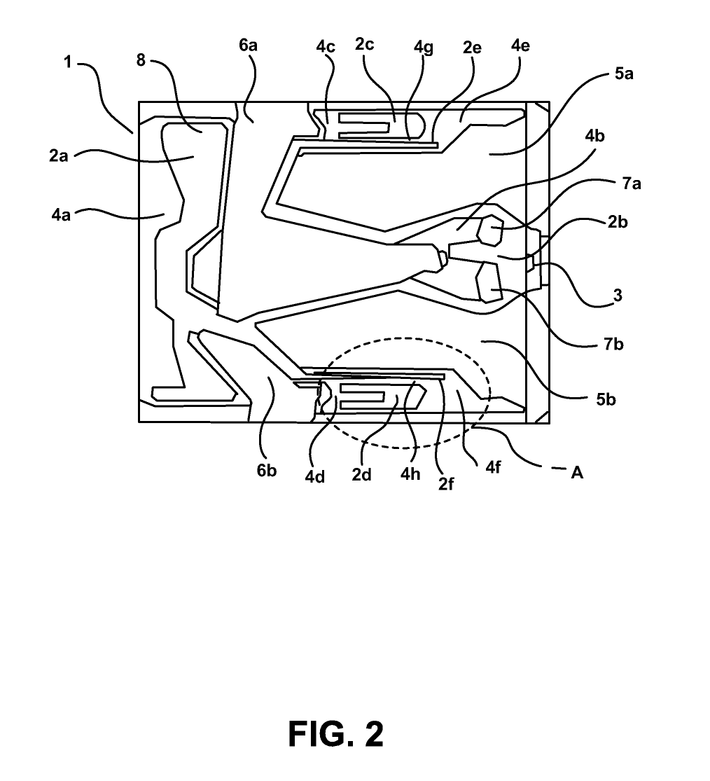

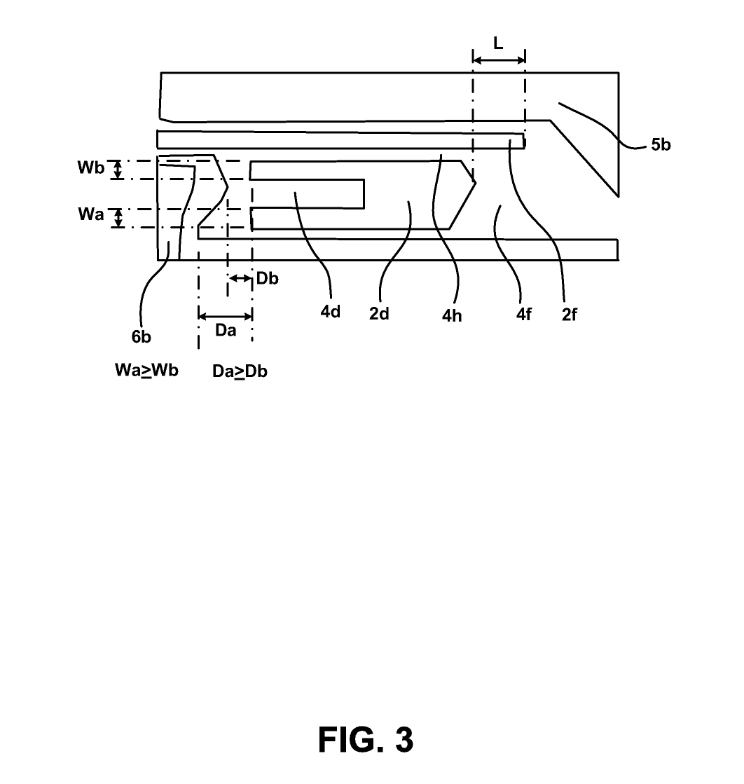

FIG. 1 is a perspective view of a magnetic head slider according to an embodiment. FIG. 2 is a plan view of FIG. 1. FIG. 3 is a view to a larger scale of a portion of the side air bearing surfaces of FIG. 2.

In these figures, in order for a levitating force to be generated by application of the air bearing effect, the magnetic head slider is formed with inlet-side shallow groove faces 4a on the inner side of the air bearing surface 8 (surface opposite the disk) of the slider 1. Also, the magnetic head slider is formed with inlet-side levitating faces 2a adjacent to the shallow groove faces 4a to the rear of these. On the other hand, a center pad levitating face 2b is formed in the middle in the width direction of the outlet end of the slider 1, where the magnetic head 3 is mounted. Pockets 7a, 7b are formed from the center shallow groove face 4b and the two second deep groove faces, on the inlet side of the center pad levitating face 2b. Deep groove faces 5a, 5b of wide area are formed towards the inlet side on both sides of the center pad levitating face 2b.

Levitating faces 2e, 2f enclose the negative pressure generating face so as to respectively enclose the inlet side of the deep groove faces 5a, 5b. Levitating faces 2e, 2f are formed from both sides of the center pad levitating face 2b. Side levitating faces 2c, 2d are separated by levitating face separating shallow groove faces 4g, 4h and are formed on the outside of the levitating faces 2e, 2f enclosing the negative pressure generating face. Side levitating faces 2c, 2d are substantially U-shaped, with the side where the U is open being formed on the inlet side. On the inlet side of the side levitating faces 2c, 2d, side inlet-side shallow groove faces 4c, 4d are formed, and side outlet-side shallow groove faces 4e, 4f are formed to the rear of the side levitating faces 2c, 2d.

Second deep-groove faces 6a, 6b are formed on the inlet side of the levitating faces 2e, 2f enclosing the negative pressure-generating face. Second deep-groove faces 6a, 6b serve to separate the interactions between the outlet-side levitating faces and the inlet-side levitating faces. Also, the second deep-groove face 6a extends right up to the center pad levitating face 2b and provides a good supply of air to the center shallow groove face 4b and the center pad levitating face 2b. In one embodiment, a levitating face 2f, that encloses the negative pressure generating face, is provided at the outer periphery. The inlet side levitating face 2a is linked with the levitating face 2f at the same height.

In various embodiments, the slider length is 0.85 mm and the slider width is 0.7 mm. Also, the depth from the levitating face of the shallow-groove face is about 170 nm, the depth from the levitating face of the deep-groove face is 970 nm, and the depth from the levitating face of the second deep-groove faces 6a and 6b is 4170 nm.

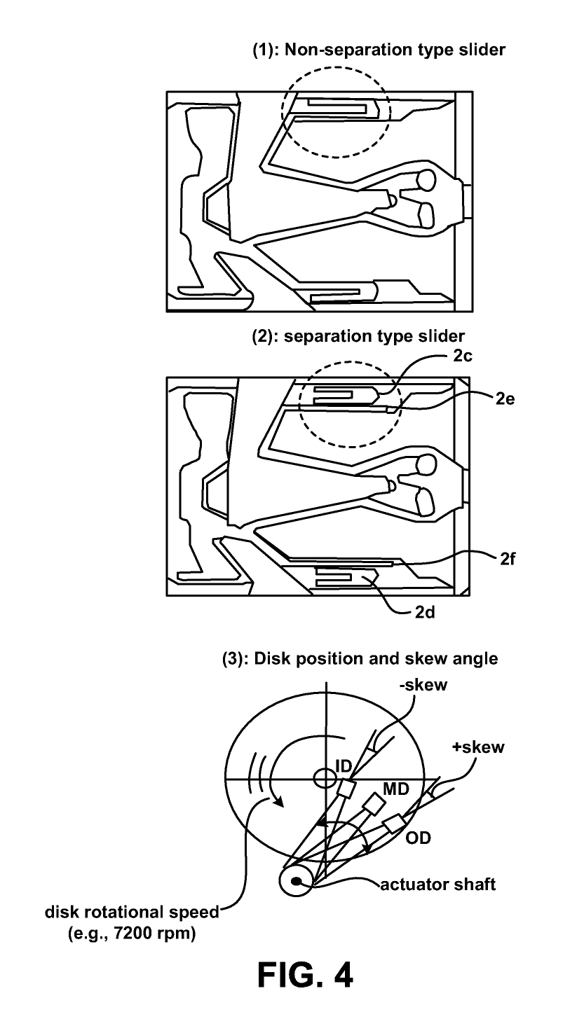

In accordance to one embodiment, FIG. 4(1) shows a magnetic head slider in which the side levitating faces 2c, 2d are not separated from the levitating faces 2e, 2f that enclose the negative pressure generating face. This type of magnetic head slider will be termed a non-separated type slider. In other words, the side levitating faces 2c, 2d are linked with and also serve as the levitating faces 2e, 2f that enclose the negative pressure generating face.

In accordance to another embodiment, FIG. 4(2) shows a magnetic head slider in which the side levitating faces 2c, 2d are separated from and independent of the levitating faces 2e, 2f that enclose the negative pressure generating face. This type of magnetic head slider will be termed a separated type slider.

In accordance to one embodiment, FIG. 4(3) shows the relationship between disk position and the skew angle. The skew angle indicates the angle between the slider longitudinal direction and the disk tangential direction. At the inner peripheral position (ID), the skew angle is a negative angle and at the outer peripheral position (OD) the skew angle is a positive angle.

In various embodiments, the skew angle is 12° at the ID, the skew angle being 0° at the intermediate circumference (MD) and +16° at the OD. The disk rotational speed is 7200 rpm.

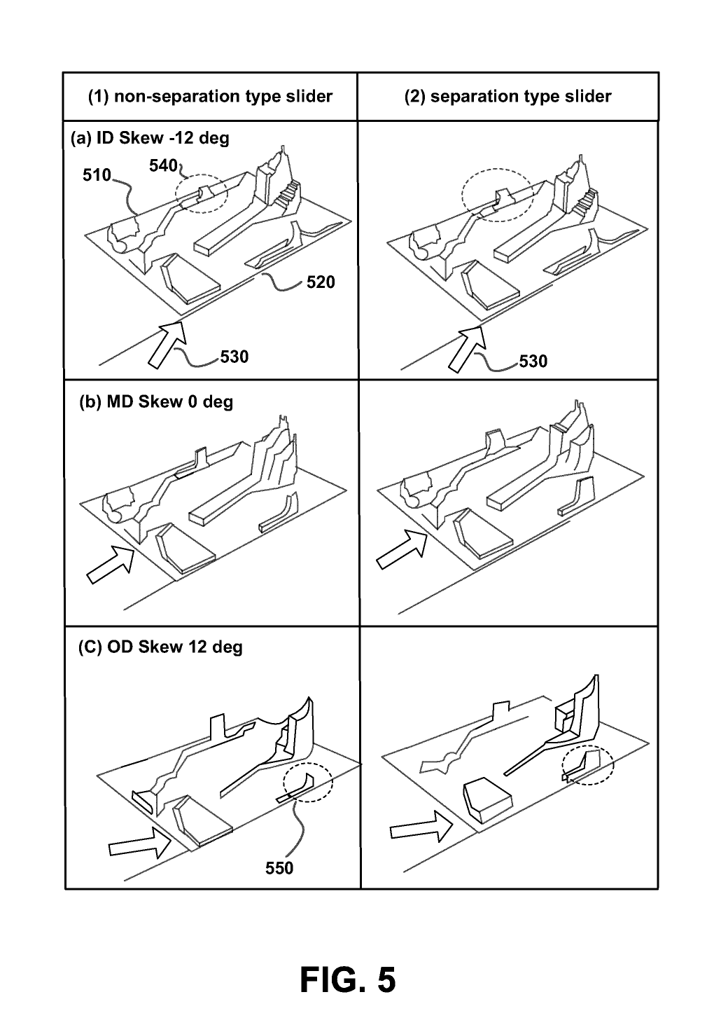

FIG. 5 is a view showing the differences relating to pressure distribution at different disk positions for the case of a slider of the non-separated type and a slider of the separated type, respectively. A comparison of the pressure distribution is shown for the case where the levitation condition of both of these is substantially the same.

At the ID position, in the case of a non-separated type slider, large pressure is generated at the side levitating faces on the inner peripheral side 510, which is the air inlet direction. However, in the case of the side levitating faces on the outer peripheral side 520 where the air flows in from the negative pressure generating face 530, an insufficient amount of air is supplied to the side levitating faces, with the result that a considerable pressure diminution occurs at location 540. As a result, the air film rigidity in the roll direction becomes small.

In the case of a separated type slider, where side levitating faces and the levitating faces enclosing the negative pressure generating face are separated by the levitating face separating shallow groove face, the rate of supply of air can be considerably increased. Accordingly, in this embodiment, large pressure is generated, even at the side levitating faces on the outer peripheral side where the air flows in from the negative pressure generating face, without being affected by the negative pressure at the negative pressure generating face. As a result, the air film rigidity in the roll direction can be increased. It should be appreciated that the pressure generated on the left and right sides are the same.

Next, at the MD position, in the case of the non-separated type slider, the pair of left and right pressures are balanced, due to the effect of the negative pressure generating face. The pressure that is generated becomes small. In contrast, in the case of the separated type slider, the construction is such that the negative pressure generating face has no effect, so large pressure is generated at each side levitating face.

Next, at the OD position, in the case of the non-separated type slider, the air inlet direction is on the outer peripheral side, so the opposite phenomenon is generated to that in the case of the ID position. As a result, pressure generation at location 550 is small.

In contrast, in the case of the separated type slider, pressure drop due to the skew angle is prevented and the air film rigidity in the roll direction can thus be made large. Consequently, tilting of slider levitation in the roll direction is reduced, and magnetic spacing loss of the element can be reduced. Also, fluctuation of levitation in the roll direction is reduced, disk crashes are avoided, and the sliding reliability of the magnetic disk device can be improved. It should be appreciated that the pressure generated on the left and right sides are the same.

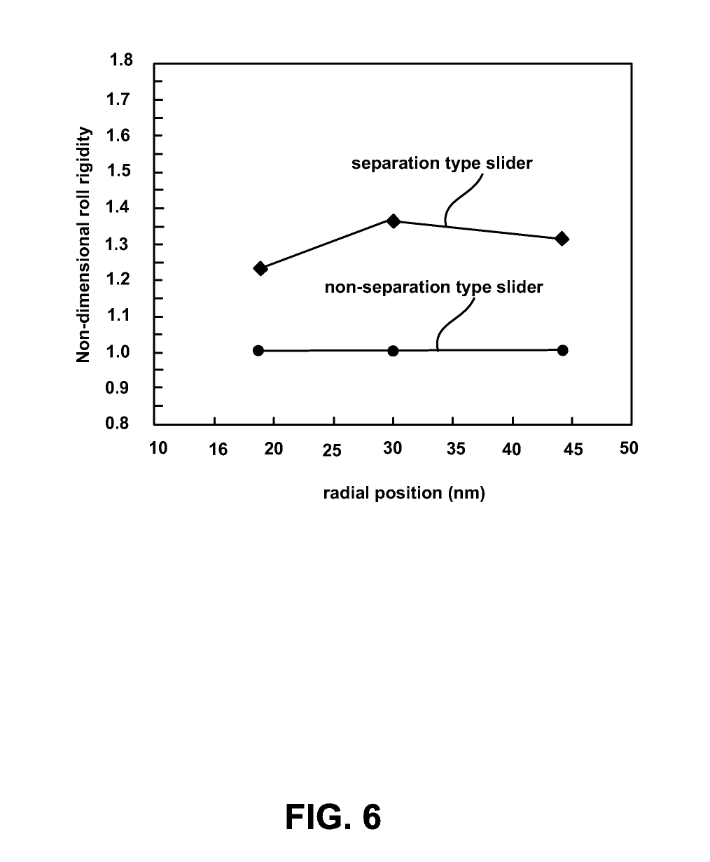

FIG. 6 shows an example of comparison of air film rigidity. FIG. 6 shows a comparison of air film rigidity of a separated type slider, taking the air film rigidity of a non-separated type slider in the roll direction as being “1”. An improvement effect of about 20% at the inner peripheral position and about 30% at the intermediate circumferential and outer peripheral positions is obtained for a separated type slider construction.

Also, in the detail view of the side levitating face portion 2d in FIG. 3, the side levitating face 2d is U-shaped, preferably the width Wa on the outside of the U-shaped slider is greater than or equal to the width Wb on the inside thereof. Accordingly, the positive pressure center on the side levitating face is on the outer peripheral side, so the air film rigidity in the roll direction can be further increased.

Also regarding the shape of the side inlet-side shallow groove face 4d, the distance Da from the inlet end of the inlet-side shallow groove face up to the side levitating face is preferably longer than the distance Db on the inside. Accordingly, the amount of air supplied when the air flows in from the negative pressure generating face can be further increased and the tilting of slider levitation in the roll direction when a skew angle is applied can be reduced, merely by adjustment of the amount of air supplied from the other direction.

Also, the rear end of the levitating faces 2e, 2f enclosing the negative pressure generating face is formed extending further rearwards then the rear end of the U-shaped side levitating faces 2c, 2d, by the amount of a length L. Accordingly, air film rigidity in the roll direction can be further increased.

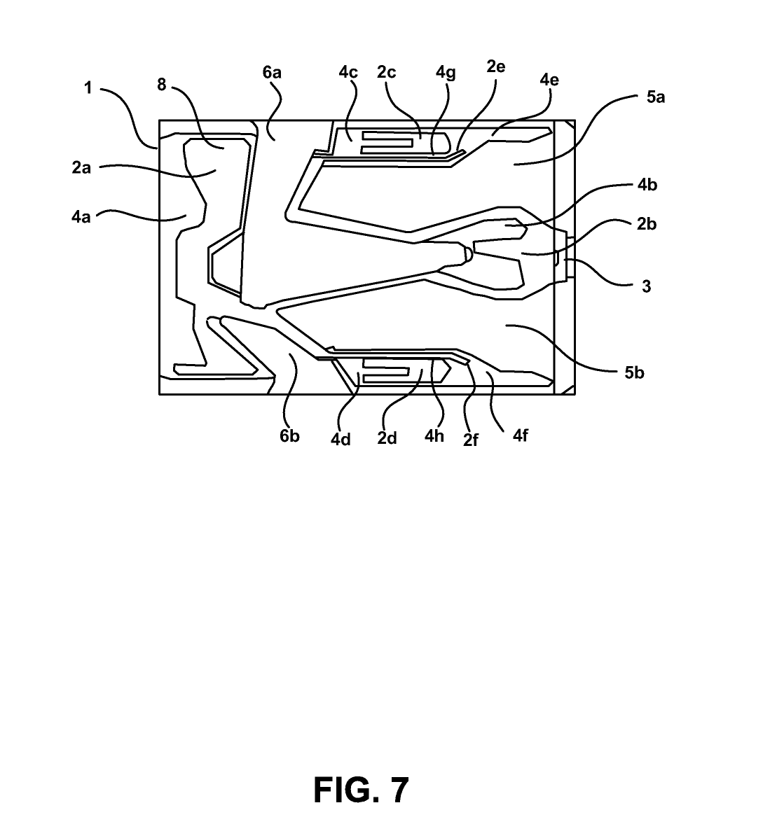

FIG. 7 shows a plan view of a magnetic head slider according to an embodiment. The levitating faces 2e, 2f enclosing the negative pressure generating face are constructed so as to extend spreading to the outside of the slider at the outlet end of the side levitating faces 2c, 2d. The amount of negative pressure can be made a little larger by widening the range of the levitating faces 2e, 2f enclosing the negative pressure generating face.

It should be noted that, although this Embodiment is an example in which the second deep groove face pockets 7a, 7b are not provided, the beneficial feature of the side levitating faces 2c, 2d is provided by the levitating faces 2e, 2f that enclose the negative pressure generating face. Accordingly, air film rigidity in the roll direction can be further increased.

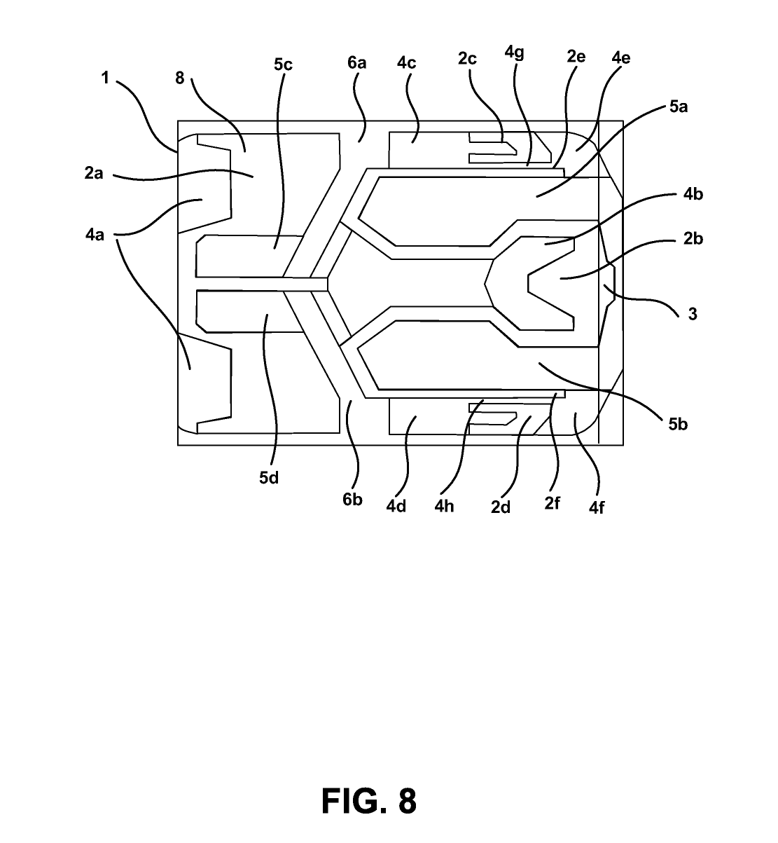

FIG. 8 shows a plan view of a magnetic head slider according to an embodiment. This magnetic head slider is a magnetic head slider of a construction in which the inlet side levitating face 2a and the other levitating faces are detached. Accordingly, air film rigidity in the roll direction can be further increased.

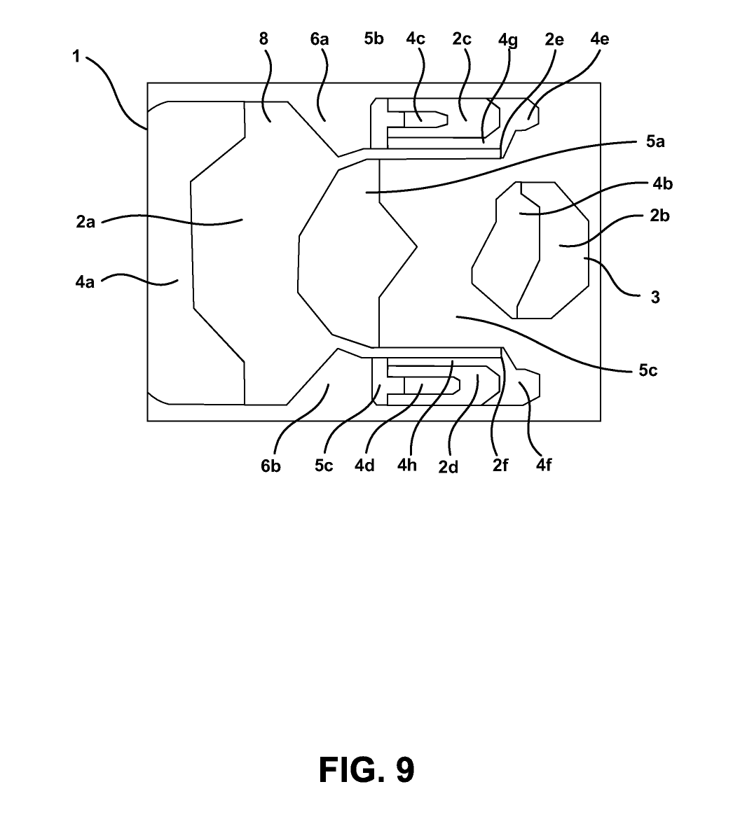

FIG. 9 shows a plan view of a magnetic head slider according to an embodiment. This magnetic head slider is an example of a magnetic head slider in which the center pad levitating face 2b is independent and a single negative pressure generating face is formed in the middle. A negative pressure generating face is constituted by forming a deep groove face 5a on the outlet side of the inlet side levitating face 2a and furthermore providing a second deep groove face 6C on the outlet side thereof. Levitating faces 2e, 2f enclosing the negative pressure generating face are formed along the aforesaid negative pressure generating face from both sides of the inlet side levitating face 2a. The levitating faces 2e, 2f enclosing the negative pressure generating face are formed so as to respectively enclose the inlet sides of the deep groove faces 5a, 5b. Side levitating faces 2c, 2d are formed, separated by levitating face separating shallow groove faces 4g, 4h, on the outside of the levitating faces 2e, 2f enclosing the negative pressure generating face. Accordingly, air film rigidity in the roll direction can be further increased.

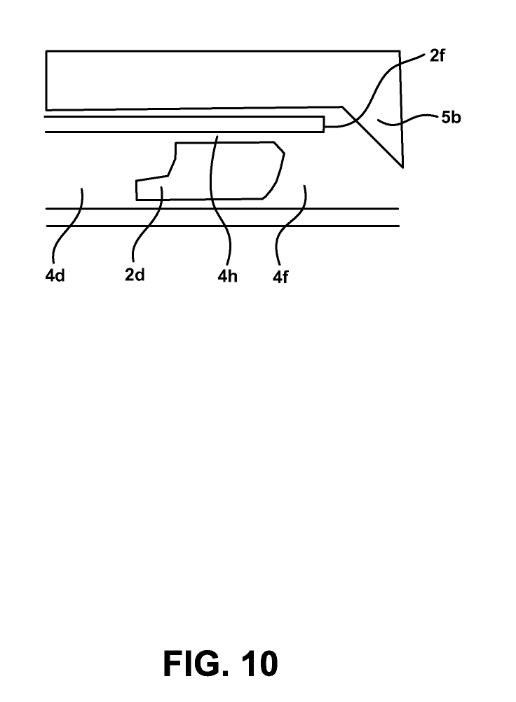

FIG. 10 shows a detail view, to a larger scale, of the magnetic head slider according to an embodiment. This is an example in which the side levitating face 2d is not of U shape. Although the positive pressure generated at the levitating face is a little less, air film rigidity in the roll direction can be further increased.

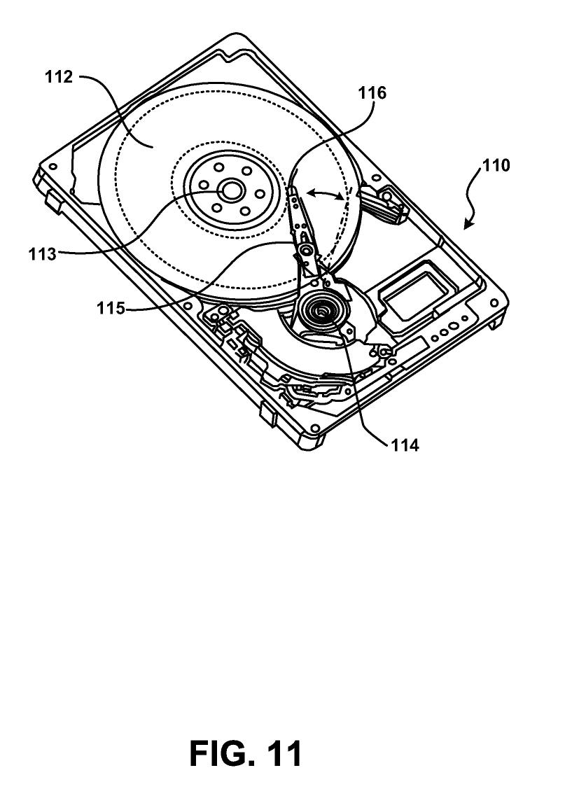

FIG. 11 shows a magnetic disk device provided with a magnetic head slider according to an embodiment. In this magnetic disk device, a disk-shaped storage medium 112 is rotatably supported within the casing 110 by means of a spindle motor 113. Also, a magnetic head 116 constructed as in the aforementioned embodiment is fixed at the tip of a head arm 115: this head arm 115 is supported so as to be capable of rotation in the radial direction (arrow) of the disk, by means of an actuator 114.

In various embodiments, the narrow levitating faces that enclose the inlet side of the negative pressure generating face are separated from the side levitating faces. Consequently, the present invention has the beneficial effects that a large positive pressure is always generated at the side levitating faces on both sides of the slider at all skew angles from the inner periphery to the outer periphery of the magnetic disk. Thus high air film rigidity in the roll direction is ensured, tilting of slider levitation in the roll direction is reduced, magnetic spacing loss of the element is decreased, and levitation fluctuation in the roll direction is reduced, avoiding disk crashes and improving the sliding reliability of the magnetic disk device.

Various embodiments of the present invention are thus described. While the present invention has been described in particular embodiments, it should be appreciated that the present invention should not be construed as limited by such embodiments, but rather construed according to the following claims.

1. A magnetic head slider comprising:
a first face adjacent to a recording medium;
a shallow groove face formed at a first depth from said first face;
a deep groove face formed at a second depth from said first face, where said second depth is greater than said first depth;
a negative pressure generating face comprising said deep groove face;
first levitating faces enclosing a periphery of said negative pressure generating face on an inlet side of said head slider; and
second levitating faces formed on opposite sides of said head slider, wherein said first levitating faces and said second levitating faces are separated.

2. The magnetic head slider of claim 1, comprising:
a width of 0.7 mm or less.

3. The magnetic head slider of claim 1, wherein said second levitating faces form a U-shape and an open side of said U-shape is formed on said inlet side of said head slider.

4. The magnetic head slider of claim 3, wherein a distance from said shallow groove face to one of said second levitating faces on said inlet side is be longer on an outside of said head slider and shorter on said inside of said head slider.

5. The magnetic head slider of claim 3, wherein said second levitating faces are formed with an outside width on an outside of said head slider that is wider than an inside width on said inside of said head slider.

6. The magnetic head slider of claim 1, wherein said first levitating faces that enclose said negative pressure generating face is formed so that its width spreads out to a rear of said head slider and in a longitudinal direction of said second levitating face.

7. The magnetic head slider of claim 3, wherein a rearward end of one of said first levitating faces is formed extending further rearward than a rearward end of one of said second levitating faces.

8. The magnetic head slider of claim 1, wherein said first depth is substantially 170 nm.

9. The magnetic head slider of claim 1, wherein said second depth is substantially 970 nm.

10. The magnetic head slider of claim 1, comprising:
a second deep groove face comprising a depth of substantially 4170 nm.

11. The magnetic head slider of claim 1, comprising a length of substantially 0.85 mm.
